(19) United States
(12) Patent Application Publication
(10) Pub. No.: US 2023/0094946 A1
(43) Pub. Date: Mar. 30, 2023

(54) Metal Body, Fitting Connection Terminal, and Method for Forming Metal Body

(71) Applicant: Senju Metal Industry Co., Ltd., Tokyo (JP)

(72) Inventors: Hiroyuki Iwamoto, Tokyo (JP); Osamu Munekata, Tokyo (JP); Kaichi Tsuruta, Tokyo (JP); Katsuji Nakamura, Tokyo (JP); Shigeki Kondoh, Tokyo (JP); Masato Tsuchiya, Tokyo (JP)

(21) Appl. No.: 17/800,714

(22) PCT Filed: Dec. 28, 2020
(86) PCT No.: PCT/JP2020/049267

§ 371 Date: Aug. 18, 2022

(30) Foreign Application Priority Data
Feb. 19, 2020 (JP) 2020-025773

(51) Int. Cl. H01R 13/03; H01R 43/16; C25D 3/12; C25D 7/00; C25D 5/18

(52) U.S. Cl. CPC H01R 13/03; H01R 43/16; C25D 3/12; C25D 7/00; C25D 5/18

(57) ABSTRACT

Provided are a metal body that can be manufactured easily while whisker generation resulting from external stress is suppressed, a fitting connection terminal, and a method for forming the metal body. The metal body includes a barrier layer containing Ni as a main component formed on a metal substrate containing Cu as a main component, and a metal plating layer containing Sn as a main component formed directly on the barrier layer. An area ratio that is a ratio of the area of an intermetallic compound containing Sn and Cu in the metal plating layer to a cross section of the metal plating layer is 20% or less in the cross section of the metal body.

### CROSS-REFERENCE TO RELATED APPLICATIONS

This application is the United States national phase of International Application No. PCT/JP2020/049267 filed Dec. 28, 2020, and claims priority to Japanese Patent Application No. 2020-025773 filed Feb. 19, 2020, the disclosures of which are hereby incorporated by reference in their entirety.

### BACKGROUND

### Field

The present invention relates to a metal body in which whisker generation is suppressed, a fitting connection terminal, and a method for forming the metal body.

### Description of Related Art

While the downsizing of electronic parts has been progressing in recent years, as the pitch intervals are reduced in fitting connection terminals such as connectors, the electrode areas tend to decrease. As the electrode areas are reduced in, for example, connectors to be used for FPCs (Flexible Printed Circuits) or FFCs (Flexible Flat Cables), pressure applied to contact portions with contacts increases relatively.

Sn plating layers containing Sn as the main component are provided on electrodes to be used for connectors and the like conventionally from the viewpoint of oxidation suppression. When a male connector is fit to a female connector, pressure is applied due to the contact of an Sn plating layer with a contact portion, and whiskers may be generated from portions on which stress is concentrated on the Sn plating layer. Whiskers generated on Sn plating layers are needle crystals of Sn, and cause short circuits in connectors for FPCs/FFCs with small pitch intervals. Examples of the causes of the whiskers include various causes besides pressure from outside as mentioned above. For example, when an Sn plating layer is formed, the volume expands due to the growth of an intermetallic compound, and whiskers may be generated by the compressive stress that occurs in the Sn plating layer.

It is therefore believed that when external stress is applied to an Sn plating layer, whiskers are generated from portions on which compressive stress is concentrated. In order to prevent stress from being concentrated on the inside of an Sn plating layer, for example, the growth of an intermetallic compound only has to be suppressed in the Sn plating layer.

In Patent Literature 1, the suppression of the intermetallic compound growth in an Sn plating layer is examined. The same literature discloses a conductive material in which an intermediate layer having an Ni layer and a Cu-Sn layer and an Sn plating layer are sequentially formed on the surface of a substrate containing Cu or Cu alloy and having no affected layer to suppress Cu diffusion and improve heat resistance. Since the conductive material described in the same literature have no affected layer in the substrate, the Ni layer can grow epitaxially on the substrate, and the average crystal grain size of the Ni layer is as large as 1 μm or more. The paragraph 0008 in the same literature discloses that since Cu diffuses in the grain boundary of the Ni layer as diffusion paths, the diffusion paths are reduced by increasing the crystal grain size of Ni, the Ni layer is made to function as a barrier layer. It is believed that the layers layered on the substrate are formed using the direct-current plating method in view of conditions for plating treatment described in the same literature.

Meanwhile, the modification of methods for forming plating which have been performed conventionally for suppressing external stress whiskers have been examined. Patent Literature 2 discloses a technique for suppressing whiskers using the pulse plating method. The same literature discloses that a discontinuous surface is formed in an Sn plating layer by adjusting the ratio between energization time and stop time in the pulse plating method, and the transfer of Sn atoms is inhibited by the discontinuous surface, and the growth of whiskers is suppressed.

Patent Literature 3 discloses a technique for suppressing whisker generation using the PR plating method, in which the current flow direction is reversed periodically. The same literature discloses that whisker generation is suppressed by adjusting energization time and the current density for respective forward current and reverse current. The same literature also discloses that if current density exceeds 3 A/dm², the degree of whisker generation increases.

Patent Literature 4 discloses a technique in which if energization is performed under the conditions that energization time for reverse current is 20% or more of time for forward current in the PR plating method, needle or thready crystals generated on the plating coating surface can be prevented from being deposited abnormally. The same literature discloses that the plating current density is 5 A/dm² or less, and it is recommended that the plating current density be 4.5 A/dm².

Patent Literature 1: Japanese Patent Laid-Open No. 2014-122403

Patent Literature 2: Japanese Patent Laid-Open No. 2006-307328

Patent Literature 3: Japanese Patent Laid-Open No. 63-118093

Patent Literature 4: Japanese Patent Laid-Open No. 2004-204308

### SUMMARY

However, an object of the invention described in Patent Literature 1 is to suppress the disappearance of the Sn plating layer at high temperature and maintain stable contact resistance by suppressing the diffusion of Cu from the substrate. Here, a Cu plating layer and an Sn plating layer are formed on the Ni layer, and Cu and Sn are diffused by reflow treatment to form the Cu—Sn layer described in Patent Literature 1. That is, although the Cu—Sn layer formed on the interface between the Cu plating layer and the Sn plating layer is noticed in Patent Literature 1, the diffusion of Cu into the Sn plating layer is not considered in view of the above-mentioned object of suppressing the disappearance of the Sn layer at high temperature.

In the invention described in Patent Literature 1, it is supposed that the effect of suppressing the diffusion of Cu from the substrate by increasing the crystal grain size of the Ni layer is obtained. Even though the crystal grain size of the Ni layer increases, crystal grain boundaries however remain, the diffusion paths of Cu are not therefore lost. Further examination is required to suppress the diffusion of Cu. As mentioned above, it is additionally necessary to provide Cu plating and also perform reflow treatment to manufacture conductive material described in Patent Literature 1, and the manufacturing process is therefore complicated. Cost reduction by the simplification of manufacturing processes has to always be pursued.

In the invention described in Patent Literature 2, it is supposed as mentioned above that the discontinuous surface is formed on the Sn plating layer by the pulse plating method, and whisker generation is suppressed. Although current flows as pulsed current periodically, the polarity of the current is however the same. Even though the transfer of Sn can be suppressed, Cu therefore diffuses into the Sn plating layer formed by pulsed current from the Cu substrate, an intermetallic compound grows, and whiskers are generated.

In Patent Literature 3 and Patent Literature 4, the PR (periodic reverse) plating method in which the current density is 5 A/dm² or less is adopted to form the Sn plating layer. In these literatures, a case that the current density is adjusted to 5 A/dm² or more is not however examined. It is considered that this is because an object in the invention described in Patent Literature 3 is to suppress the whisker generated spontaneously after the formation of the Sn plating layer, and an object in the invention described in Patent Literature 4 is to suppress abnormal deposition when the Sn plating layer is formed. Patent Literature 4 discloses that an electrolytic double layer deposited when electrolytic deposition is continued is vanished, and the concentration of local plating deposition is prevented. Patent Literature 4 recommends that the current density be reduced. Even though the concentration of plating deposition is prevented, the intermetallic compound however grows in the Sn plating layer, or many crystal grains in a predetermined crystal orientation is present at low current density, and whiskers may grow due to external stress. Since, in the PR plating method described in Patent Literatures 3 and 4, forward current and reverse current with low current density are passed for certain periods of time, it takes time to form plating, and an improvement is further required from the viewpoint of cost reduction.

An object of the present invention is to provide a metal body that can be manufactured easily while whisker generation resulting from external stress is suppressed, a fitting connection terminal, and a method for forming the metal body.

The present inventors have reexamined a cause for whiskers to be generated in a conductive material described in Patent Literature 1 in view of difficulty in avoiding external stress applied to an Sn plating layer in a situation such as a connector to which external stress is applied. Examples of the cause therefor include the fact that, although an object is to suppress the diffusion of Cu in the invention described in Patent Literature 1, the Cu plating layer has to be formed.

The present inventors have investigated a cause for Cu to diffuse at the time of electroplating under the conditions that the Cu plating layer is not formed and reflow treatment is not performed in the conductive material described in Patent Literature 1. The Ni-plated Cu substrate was subjected to electrolysis test in dilute sulfuric acid using an SUS plate as the anode, and the Ni-plated Cu substrate was analyzed for the surface condition after the test. The concentration of Cu was consequently seen on the surface of the Ni plating layer, and the information that as the current density increased, the amount of Cu diffused increased was obtained. It is inferred from this that, in the conventional method described in Patent Literature 1, the below-mentioned bipolar phenomenon occurs between the Cu substrate and the Ni plating layer, the Ni plating layer functions as the cathode, the Cu substrate functions as the anode, the potential difference is therefore made, and Cu diffuses on the surface of Sn plating layer through the Ni plating. It is believed as to this that the same phenomenon occurs also in the pulse plating method, in which the polarity of current is the same.

Then, the present inventors have not adopted the direct-current plating method described in Patent Literature 1 or the pulse plating method described in Patent Literature 2 but the PR plating methods described in Patent Literature 3 and Patent Literature 4 so that the bipolar phenomenon does not occur. In Patent Literature 3, an Sn plating layer was formed at high current density supposed to generate whiskers to a high degree to suppress whiskers resulting from external stress. Accidentally, the growth of an intermetallic compound formed on the Sn plating layer was consequently suppressed. The information that even though external stress was applied to the Sn plating layer, the growth of whiskers was able to be suppressed was obtained.

This is inferred as follows. When the current density increases in the PR plating method, a large amount of Sn is dissolved on the cathode surface at the time of current reversal, the Sn ion concentration near the cathode therefore increases. When forward current is passed, Sn is deposited fine, Cu diffusion paths from a substrate becomes fine, or is divided. Therefore, the bipolar phenomenon is suppressed, the growth of an intermetallic compound in a metal plating layer is suppressed even when forward current is passed, and the growth of external stress whiskers can be suppressed.

Furthermore, the present inventors have investigated the relationship among an angle that a c axis in a crystal orientation of f3Sn forms with the film thickness direction (hereinafter suitably called an “inclination angle”), the X-ray diffraction spectral intensity, and the maximum whisker length shown in Table 1 from an X-ray diffraction spectrum of the Sn plating layer. In the investigation, the present inventors have noticed the sum of the maximum peak intensity ratio in the X diffraction spectrum and an intensity ratio in a crystal orientation having an inclination angle approximate to that of the c axis in a crystal orientation exhibiting the maximum peak intensity ratio. The information that if the sum of these intensity ratios was 59.4% or less, the growth of an intermetallic compound was suppressed, and the growth of the whisker due to external stress was able to be further suppressed in combination therewith was obtained.

The present invention completed by this information is as follows.

(1) A metal body, comprising a barrier layer comprising Ni as a main component formed on a metal substrate comprising Cu as a main component, and a metal plating layer comprising Sn as a main component formed directly on the barrier layer, wherein, in a cross section of the metal body, an area ratio that is a ratio of an area of an intermetallic compound containing Sn and Cu in the metal plating layer to a cross section of the metal plating layer is 20% or less.

(2) The metal body according to the above (1), wherein the metal plating layer comprises an Sn-based alloy containing at least one selected from Ag, Bi, Cu, In, Ni, Co, Ge, Ga, Sb, and P.

(3) The metal body according to the above (1) or the above (2), wherein, in an X-ray diffraction spectrum of the metal plating layer, a sum of a peak intensity ratio (%) in a crystal orientation exhibiting a maximum peak intensity and a peak intensity ratio (%) in a crystal orientation in which an angle difference between a maximum peak inclination angle and a non-maximum peak inclination angle is in the range of ±6° is 59.4% or less, in which the maximum peak inclination angle is an angle that a c axis in the crystal orientation exhibiting the maximum peak intensity and a film thickness direction of the metal plating layer form and the non-maximum peak inclination angle that is an angle that a c axis in a crystal orientation exhibiting a peak intensity other than the maximum peak intensity and the film thickness direction of the metal plating layer form.

(4) The metal body according to any one of the above (1) to the above (3), wherein a surface roughness of the metal plating layer is 0.306 μm or less.

(5) The metal body according to any one of the above (1) to the above (4), wherein an average crystal grain size of the metal plating layer is 2.44 μm or more.

(6) The metal body according to any one of the above (1) to the above (5), wherein a Vickers hardness of the metal plating layer is 14.1 HV or less.

(7) A fitting connection terminal, comprising the metal body according to any one of the above (1) to the above (6).

(8) A method for forming the metal body according to any one of the above (1) to the above (6), comprising: a barrier layer formation step of forming a barrier layer containing Ni as a main component on a metal substrate containing Cu as a main component; and a metal plating layer formation step of forming a metal plating layer directly on the barrier layer by PR plating treatment in which a current density is more than 5 A/dm² and 50 A/dm² or less, and a duty ratio is more than 0.8 and less than 1.

(9) The method for forming the metal body according to the above (8), wherein, in the PR plating treatment, a forward current value of a forward current passed to deposit a metal directly on the barrier layer is lower than a reverse current value of a reverse current passed to dissolve the metal directly on the barrier layer.

### BRIEF DESCRIPTION OF THE DRAWINGS

FIG. 1 is a schematic diagram showing a whisker growth mechanism at the time of applying external stress if c axes in crystal orientations constituting βSn are comparatively aligned.

FIG. 2 is a schematic diagram showing a whisker growth suppression mechanism at the time of applying external stress if c axes in crystal orientations constituting βSn are not comparatively aligned.

FIG. 3 is reference figures for calculating an inclination angle, (a) of FIG. 3 is a reference figure showing the a axis, the b axis, and the c axis of a tetragonal crystal, (b) of FIG. 3 is a reference figure for calculating the inclination angle θ that the Z-axis and the c axis in a crystal face of βSn form if the crystal face intersects the X-, Y-, Z-axes, and (c) of FIG. 3 is a reference figure for calculating the inclination angle θ by another method, the inclination angle θ being formed by the Z-axis and the c axis of a crystal face of βSn if the crystal face intersects the X-, Y-, and Z-axes.

FIG. 4 is a schematic diagram for describing a prospective mechanism in which a bipolar phenomenon when a metal plating layer is formed using the direct-current plating method occurs.

FIG. 5 shows a sectional SEM photograph of Comparative Example 1.

FIG. 6 shows a sectional SEM photograph of Example 1 according to the present invention.

FIG. 7 is a figure showing the relationship between the area ratio of an intermetallic compound and whisker length.

FIG. 8 is a figure showing the X-ray diffraction spectrum of Comparative Example 1.

FIG. 9 is a figure showing the X-ray diffraction spectrum of Example 1 according to the present invention.

### DETAILED DESCRIPTION

Hereinafter, the present invention will be described in detail.

### 1. Metal Body

### (1) Metal Substrate Containing Cu as Main Component

A metal substrate containing Cu as the main component is used for a metal body according to the present invention. The metal substrate containing Cu as the main component means that the Cu content is 50% by mass or more of the metal substrate, and it is preferable that the Cu content be 100% by mass. The metal substrate includes Cu alloy and pure Cu. Inevitable impurities may be contained in the balance. Examples of the metal substrate to be used in the present invention include a metal substrate for constituting terminal connection portions (junction regions) of FFCs or FPCs and a metal substrate for constituting electrodes.

Although the thickness of the metal substrate is not particularly limited, the thickness maybe 0.05 to 0.5 mm from the viewpoint of securing the strength of the metal body and the slimming down of the metal body.

### (2) Barrier Layer

The metal body according to the present invention comprises a barrier layer in which the main component is Ni directly on the metal substrate. The barrier layer suppresses the diffusion of Cu contained in the metal substrate. The barrier layer in which the main component is Ni means that the Ni content is 50% by mass or more of the barrier layer. A preferable Ni content is 100% by mass. The barrier layer includes Ni alloy and pure Ni. Inevitable impurities may be contained in the balance.

The barrier layer can suppress the diffusion of Cu from the metal substrate to the metal plating layer. Although the film thickness or the crystal grain size is not particularly limited, the film thickness may be 0.1 to 5 μm, and the crystal grain size may be 0.1 to 2.0 μm.

### (3) Metal Plating Layer Containing Sn as Main Component

### (3-1) Composition of Metal Plating Layer

In the metal body according to the present invention, a metal plating layer containing Sn as the main component is formed on the barrier layer. The metal plating layer prevents the oxidation of the metal substrate. The metal plating layer containing Sn as the main component means that the Sn content is 50% by mass or more of the metal plating layer. A preferable Sn content is 100% by mass. The metal plating layer includes Sn-based alloy and pure Sn. Inevitable impurities may be contained in the balance.

As long as an effect of the present invention is not inhibited, at least one selected from Ag, Bi, Cu, In, Ni, Co, Ge, Ga, and P may be contained as an optional element in the case that the metal plating layer is an Sn-based alloy. It is preferable that the content thereof be 5% by mass or less of the total mass of the metal plating layer.

It is preferable that the film thickness of the metal plating layer be adjusted to 1 to 7 μm in view of manufacturing cost or manufacturing time.

### (3-2) Intermetallic Compound

When Cu of the metal substrate is subjected to solid phase diffusion into the metal plating layer, an intermetallic compound containing Sn and Cu may be formed in the metal plating layer according to the present invention. As mentioned below, the metal plating layer is formed using the PR plating method under predetermined conditions in the metal body according to the present invention. The diffusion of Cu from the metal substrate is therefore suppressed, so that the growth of the intermetallic compound is suppressed.

Since the barrier layer is formed in the metal body according to the present invention, it is preferable that the intermetallic compound be (Cu, Ni)₆Sn₅. Cu₆Sn₅ or Cu₃Sn may be partially formed.

In the present invention, in a cross section of the metal body according to the present invention, an area ratio that is the ratio of the area of the intermetallic compound to the cross section of the metal plating layer is 20% or less. If the area ratio is 20% or less, the intermetallic compound is dispersed in the metal plating layer, and an increase in internal stress is therefore suppressed, so that whisker generation is suppressed. The area ratio is preferably 15.0% or less, more preferably 11.0% or less, further preferably 8.0% or less, and particularly preferably 4.0% or less. Although the lower limit is not particularly limited, the lower limit is 0% or more.

### (3-2-1) Method for Calculating Area Ratio

The area ratio of the intermetallic compound in the present invention is calculated as follows. Microprocessing for exposing a section is performed by a focused ion beam (FIB), the section is subjected to qualitative analysis with an energy dispersive X-ray spectroscope (EDS), and the intermetallic compound is identified. After the identification of the intermetallic compound, the area of the intermetallic compound present in the metal plating layer formed on the Ni plating layer is determined from a sectional SEM photograph using image-processing software. The FIB processing width and the film thickness of the metal plating layer are obtained from the sectional SEM photograph, and the total cross section of the metal plating layer is calculated from them.

The area ratio is finally calculated by {(area of intermetallic compound (μm²))/(total cross section of metal plating layer (μm²))}×100 (%) from the thus obtained area of the intermetallic compound and the thus obtained cross section of the metal plating layer.

### (3-2-2) Mechanism of Present Invention

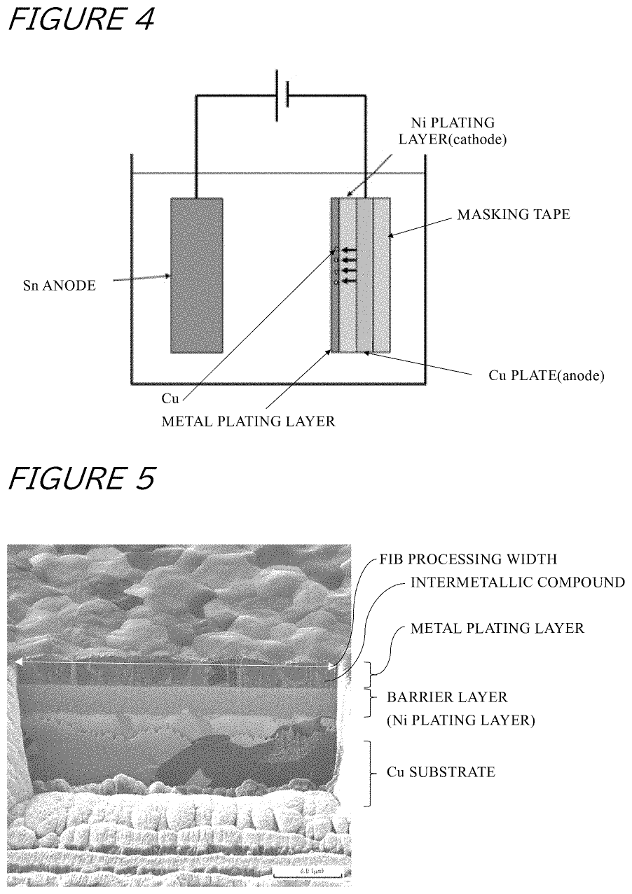

The diffusion of Cu was promoted by the occurrence of a bipolar phenomenon in the direct-current plating method, adopted conventionally. The bipolar phenomenon will be described in detail using FIG. 4. FIG. 4 is a schematic diagram for describing a prospective mechanism in which a bipolar phenomenon when the metal plating layer is formed using the direct-current plating method occurs. As shown in FIG. 4, when the Sn plating layer is provided on the Cu plate comprising the Ni plating layer, an Sn anode is connected on the anode side, and a Cu plate (Cu substrate) is connected on the cathode side. When direct-current current is passed in this connection state, the potential difference is made in the cathode, the interface with the Ni plating layer functions as an anode in the Cu plate, and the Ni plating layer functions as a cathode. Therefore, Cu of the Cu plate passes the grain boundary interface of the Ni plating layer, diffuses into the Sn plating layer, and the intermetallic compound grows in the Sn plating layer. This is the “bipolar phenomenon” in the present invention. When the intermetallic compound grows, internal stress increases. When external stress is applied, whiskers are therefore easily generated from portions in which internal stress increases.

Although pulsed current is current that flows periodically, the polarity is in the same direction. In a metal plating layer layered by pulsed current, the intermetallic compound therefore grows, and whiskers are generated as compared with the metal plating layer layered using the PR plating method.

In the present invention, the metal plating layer is meanwhile layered by the PR plating method, using current the polarity of which is reversed periodically. Since such periodic reverse current can reduce the potential difference made on the cathode side in the direct-current plating method, the diffusion of Cu is suppressed. Here, even though the PR plating method is used, Cu diffuses slightly at the time of the flow of current having the same polarity as direct-current current.

Even though the PR plating method is used, Sn does not however deposit fine at low current density as performed in the past, Cu therefore diffuses easily, and the intermetallic compound grows. Since only the diffusion of Sn was noticed in the past to suppress whiskers, the current density had to be reduced. If the current density is low, the amount of Sn dissolved on the surface of the cathode at the time of current reversal is small. If forward current is then passed, the amount of Sn deposited decreases, and Cu diffuses into the Sn plating layer through the crystal grain boundary connected to the Cu substrate.

Meanwhile if the current density increases in the PR plating method, a large amount of Sn dissolves on the cathode surface at the time of current reversal, the Sn ion concentration near the cathode increases. If forward current is passed, Sn deposits fine, and the crystal grain boundary is divided in places. Cu diffusion paths from the substrate therefore becomes fine, or is divided, the growth of the intermetallic compound in the metal plating layer is also suppressed when forward current is passed, and the growth of external stress whiskers can be suppressed.

It is inferred that if current having current density higher than in the past is thus passed using the PR plating method, the layered metal plating layer is layered with the diffusion of Cu suppressed, and the growth of the intermetallic compound present in the metal plating layer is therefore suppressed. It is believed that if the growth of the intermetallic compound is suppressed, an increase in internal stress is suppressed, and even though external stress is applied, whiskers do not grow.

### (4) Relationship of Crystal Orientation and Peak Intensity in Sn Constituting Metal Plating Layer With Whiskers

It is preferable that, in the metal plating layer of the present invention, the sum of a peak intensity in a crystal orientation exhibiting the maximum peak intensity in the X-ray diffraction spectrum of the metal plating layer and a peak intensity in a crystal orientation in which an angle that the c axis in the crystal orientation exhibiting the maximum peak intensity form be in the range of ±6° be 59.4% or less of the sum of all the peak intensities in the X-ray diffraction spectrum. The sum is more preferably 58.0% or less, further preferably 57.0% or less, and particularly preferably 56.0% or less.

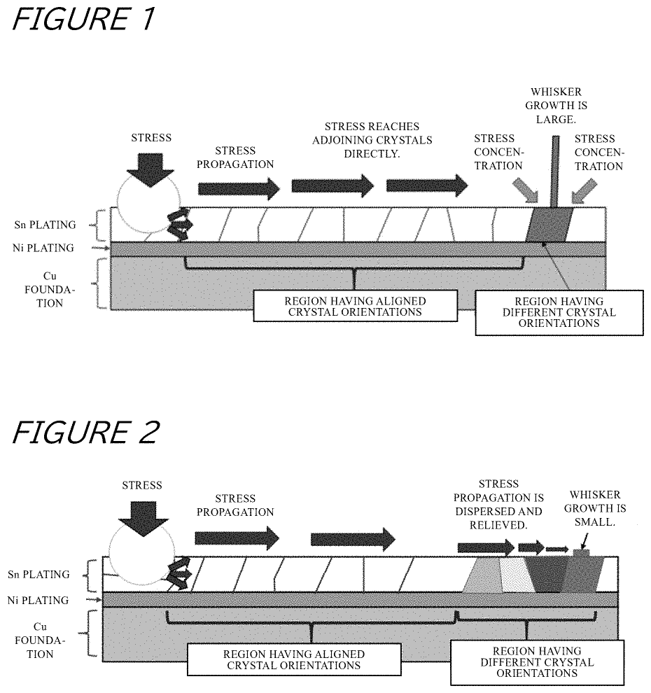

Since Sn at normal temperature and normal pressure has the crystal structure of a tetragonal crystal (βSn), its properties are significantly different depending on crystal orientations. Since a Young's modulus in the c axis direction of the crystal of βSn is high as compared with that in the a axis direction of the crystal of βSn, the crystal of βSn is hardly deformed in the c axis direction. As shown in FIG. 1, if external stress is applied to the surface of the metal plating layer, external stress therefore propagates easily as it is without being dispersed in the case that the inclination angles of the crystal orientations of βSn are aligned. If crystals the inclination angles of which are significantly different are present ahead, the propagation of compressive stress is interrupted there, compressive stress is concentrated at the portions, and whiskers grow easily. As shown in FIG. 2, if the inclination angles of crystal orientations of βSn are not aligned, in a region having many crystal orientations in which inclination angles that are angles that c axes and the film thickness direction form are significantly different, the propagation of compressive stress is meanwhile dispersed and relieved, and whisker growth is suppressed. It is inferred that in the metal plating layer of the present invention, compressive stress that acts on adjoining crystals is thus relieved in combination with reduction in the above-mentioned area ratio of the intermetallic compound, and whisker growth can be further suppressed.

According to this inference, in order to reduce the whisker length in a preferable aspect of the present invention, the sum of a peak intensity ratio (%) in a crystal orientation (A) exhibiting the maximum peak intensity in the X-ray diffraction spectrum and a peak intensity ratio (%) in a crystal orientation (B) in which the angle difference (a°−b°) between a maximum peak inclination angle (a°) that is an angle that a c axis in a crystal orientation exhibiting the maximum peak strength and the film thickness direction of the metal plating layer form and a non-maximum peak inclination angle (b°) that is an angle that a c axis in a crystal orientation exhibiting a peak intensity other than the maximum peak intensity and the film thickness direction of the metal plating layer form is in the range of ±6°, is preferably 59.4% or less. In other words, it is inferred that the sum of the intensity ratios in crystal orientations in which inclination angles of c axes are comparatively aligned corresponds to the main stress for generating whiskers, and if the sum of the intensity ratios is in the above-mentioned range, the whisker length is further shortened.

In the present invention, the peak intensity ratio means a value (%) obtained by multiplying a value obtained by dividing a peak intensity in a predetermined crystal orientation by the total peak intensity in the X diffraction spectrum by 100.

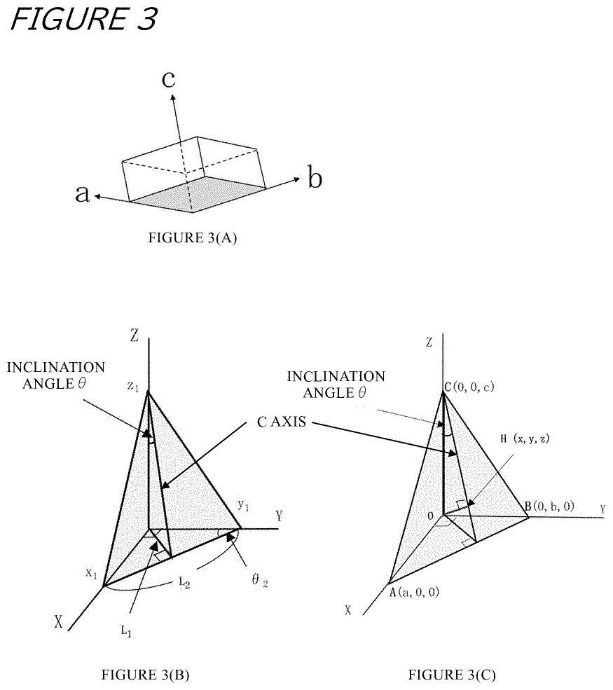

An example of a method for finding an inclination angle in the present invention will be described using FIG. 3. FIG. 3 is reference figures for calculating an inclination angle, (a) of FIG. 3 is a reference figure showing the a axis, the b axis, and the c axis of a tetragonal crystal, and (b) of FIG. 3 is a reference figure for calculating the inclination angle θ that the Z-axis and the c axis of a crystal face form if the crystal face of βSn intersects the X-, Y-, and Z-axes. The c axis of (a) of FIG. 3 corresponds to the c axes of (b) of FIG. 3 and (c) of FIG. 3.

In the present invention, the film thickness direction of the metal plating layer is defined as the Z-axis.

When the lengths of a unit cell of βSn, which is a tetragonal crystal, are defined as (a, b, c), as shown in (b) of FIG. 3, a crystal face intersects the X, Y, Z-axes at the following points, respectively.
x₁=α·a
y₁=β·b
z₁=γ·c
   A Miller index at this time is represented by an integer ratio that is (1/α:1/β:1/γ)=(h k l).

At this time, L2, θ2, L1, tanθ, and θ shown in (b) of FIG. 3 are represented as follows, respectively.

$${L}_{2} = \sqrt{{x}_{1}^{2} + {y}_{1}^{2}} \qquad [ Expression 1 ]$$

$$sin {θ}_{2} = \frac{{x}_{1}}{{L}_{2}} = \frac{{x}_{1}}{\sqrt{{x}_{1}^{2} + {y}_{1}^{2}}} \qquad [ Expression 2 ]$$

$${L}_{1} = {y}_{1} sin {θ}_{2} = \frac{{x}_{1} {y}_{1}}{\sqrt{{x}_{1}^{2} + {y}_{1}^{2}}} \qquad [ Expression 3 ]$$

$$tan θ = \frac{{L}_{1}}{{z}_{1}} = \frac{{x}_{1} {y}_{1}}{\sqrt[{z}_{1}]{{x}_{1}^{2} + {y}_{1}^{2}}} \qquad [ Expression 4 ]$$

$$θ = ARCTAN ( \frac{{x}_{1} {y}_{1}}{\sqrt[{z}_{1}]{{x}_{1}^{2} + {y}_{1}^{2}}} ) \qquad [ Expression 5 ]$$

However, if the crystal face is parallel to the Z-axis, θ=0°, and if the crystal face is perpendicular to the Z-axis, θ=90°.

If the crystal face does not intersect the Y-axis as represented by (101), θ is defined as follows.

$$θ = ARC TAN ( \frac{{x}_{1}}{{z}_{1}} ) \qquad [ Expression 6 ]$$

If the crystal face does not intersect the X-axis as represented by (011), θ is defined as follows.

$$θ = ARC TAN ( \frac{{y}_{1}}{{z}_{1}} ) \qquad [ Expression 7 ]$$

Here, the lengths of sides constituting the unit cell of the tetragonal crystal are the following: a=b=0.5831 nm and c=0.3181 nm, respectively. When these values and the above-mentioned expressions are used, the inclination angles θ of the c axes in each Miller indices are values shown in Table 1.

TABLE 1

| | | | | X-axis | Y-axis | Z-axis | | Inclination |
|---|---|---|---|---|---|---|---|---|
| | | | | intercept length | intercept length | intercept length | | angle of |
| Miller | X-axis | Y-axis | Z-axis | (X-axis intercept × | (X-axis intercept × | (X-axis intercept × | | c axis |
| index | intercept | intercept | intercept | 0.5831) | 0.5831) | 0.3181) | L1 | θ (°) |
| (200) | 1 | 0 | 0 | 0.5831 | 0.0000 | 0.0000 | — | 0.00 |
| (211) | 1 | 2 | 2 | 0.5831 | 1.1662 | 0.6362 | 0.5215 | 39.34 |
| (321) | 2 | 3 | 6 | 1.1662 | 1.7493 | 1.9086 | 0.9703 | 26.95 |
| (411) | 1 | 4 | 4 | 0.5831 | 2.3324 | 1.2724 | 0.5657 | 23.97 |
| (521) | 2 | 5 | 10 | 1.1662 | 2.9155 | 3.1810 | 1.0828 | 18.80 |
| (501) | 1 | 0 | 5 | 0.5831 | 0.0000 | 1.5905 | — | 20.13 |
| (301) | 1 | 0 | 3 | 0.5831 | 0.0000 | 0.9543 | — | 31.43 |
| (101) | 1 | 0 | 1 | 0.5831 | 0.0000 | 0.3181 | — | 61.39 |
| (221) | 1 | 1 | 2 | 0.5831 | 0.5831 | 0.6362 | 0.4123 | 32.95 |
| (332) | 2 | 2 | 3 | 1.1662 | 1.1662 | 0.9543 | 0.8246 | 40.83 |
| (112) | 2 | 2 | 1 | 1.1662 | 1.1662 | 0.3181 | 0.8246 | 68.91 |

Another example of a method for finding an inclination angle in the present invention will be described using (c) of FIG. 3.

As shown in (c) of FIG. 3, the coordinates of the intersection point H (x, y, z) when a perpendicular line is drawn from the origin to a plane defined by the three points A (a, 0, 0), B (0, b, 0), and C (0, 0, c) are calculated as follows.

When the coordinates (x, y, z) of the intersection point H are used,

\vec{AH}=(x−a, y, z)

\vec{AB}=(−a, b, O)

\vec{AC}=(−a, O, c)

\vec{OH}=(x, y, z) [Expression 8]

the above hold.

\vec{AH}⊥\vec{OH}⇔\vec{AH}·\vec{OH}⇔x(x−a)+y²+z²=O Equation 1

\vec{AB}⊥\vec{OH}⇔\vec{AB}·\vec{OH}⇔−a x+b y=O Equation 2

\vec{AC}⊥\vec{OH}⇔\vec{AC}·\vec{OH}⇔−a x+c z=O Equation 3

The following is obtained from Equation 2.

y=ax/b Equation 4

The following is obtained from Equation 3.

z=ax/c Equation 5

When Equation 4 and Equation 5 are substituted into Equation 1,

x²−ax+a²x²/b²+a²x²/c²=0

x²(1+a²/b²+a²/c²)−ax=0

x((1+a²/b²+a²/c²)x−a)=0

the above are derived.

x=a/(1+a²/b²+a²/c²) Equation 6

y=ax/b Equation 7

z=ax/c Equation 8

The above equations are obtained.

The inclination angle θ that is an angle that a c axis represented by a Miller index shown in (c) of FIG. 3 and the Z-axis form is derived using these. A derivation method in the case that the Miller index represents the plane (3, 2, 1) will be illustrated.

On the plane (3, 2, 1), the intercepts on the X-, Y-, Z-axes are (2, 3, 6), and the lengths of sides constituting the unit cell of the tetragonal crystal are: a=b=0.5831 nm and c=0.3181 nm, respectively. The lengths of the intercepts are the following in view of these.
a=2×0.5831=1.1662
b=3×0.5831=1.7493
c=6×0.3181=1.9086
   The point H (x, y, z) found from the above-mentioned Equations 6 to 8 is found as follows:
(x, y, z)=(0.6415, 0.4277, 0.3920)

The distance OH from the origin to the point H is the following.

OH=√\vec{x²+y²+z²} [Expression 10]

### OH=0.8650

The inclination angle θ is therefore calculated as follows.
sin θ=OH/OC=0.8650/1.9086=0.4532
θ=ARCSIN θ=26.95°

The inclination angles θ of the c axes in other Miller indices are values shown in Table 2.

TABLE 2

| | (200) | (211) | (321) | (411) | (521) | (501) | (301) | (101) | (221) | (332) | (112) |
|---|---|---|---|---|---|---|---|---|---|---|---|
| | Plane | Plane | Plane | Plane | Plane | Plane | Plane | Plane | Plane | Plane | Plane |
| Intercept x | 1 | 1 | 2 | 1 | 2 | 1 | 1 | 1 | 1 | 2 | 2 |
| Intercept y | 0 | 2 | 3 | 4 | 5 | 0 | 0 | 0 | 1 | 2 | 2 |
| Intercept z | 0 | 2 | 6 | 4 | 10 | 5 | 3 | 1 | 2 | 3 | 1 |
| a= | 0.5831 | 0.5831 | 1.1662 | 0.5831 | 1.1662 | 0.5831 | 0.5831 | 0.5831 | 0.5831 | 1.1662 | 1.1662 |
| b= | — | 1.1662 | 1.7493 | 2.3324 | 2.9155 | 0 | 0 | 0 | 0.5831 | 1.1662 | 1.1662 |
| c= | — | 0.6362 | 1.9086 | 1.2724 | 3.181 | 1.5905 | 0.9543 | 0.3181 | 0.6362 | 0.9543 | 0.3181 |
| x= | 0.58 | 0.28 | 0.64 | 0.46 | 0.90 | 0.51 | 0.42 | 0.13 | 0.21 | 0.33 | 0.08 |
| y= | — | 0.14 | 0.43 | 0.11 | 0.36 | 0.00 | 0.00 | 0.00 | 0.21 | 0.33 | 0.08 |
| z= | — | 0.26 | 0.39 | 0.21 | 0.33 | 0.19 | 0.26 | 0.25 | 0.19 | 0.41 | 0.28 |
| OH= | 1.00 | 0.40 | 0.86 | 0.52 | 1.03 | 0.55 | 0.50 | 0.28 | 0.35 | 0.62 | 0.30 |
| sinθ= | — | 0.6340 | 0.4532 | 0.4062 | 0.3222 | 0.3442 | 0.5214 | 0.8779 | 0.5439 | 0.6538 | 0.9330 |
| θ = ASINθ | 0 | 39.34 | 26.95 | 23.97 | 18.80 | 20.13 | 31.43 | 61.39 | 32.95 | 40.83 | 68.91 |

θ found by either method is the same value as θ found by the other method. The inclination angle θ that is an angle that the c axis in the crystal orientation of βSn (tetragonal crystal) and the Z-axis form can be found. The method for finding θ as shown in Table 1 is preferable in that the calculation in the method for finding θ as shown in Table 1 is easy as compared with that in the method for finding θ as shown in Table 2.

### (5) Surface Roughness, Average Crystal Grain Size, Vickers Hardness of Metal Plating Layer

It is preferable that the metal body according to the present invention have a metal plating layer with low surface roughness in addition to short whisker length. It is inferred that when the metal body according to the present invention is used for fitting connection terminals such as connectors, the surface roughness is low, the surface is even, portions that cause resistance at the time of the insertion and removal of the connector are therefore reduced, and insertability/removability is improved in the metal plating layer formed using a PR power supply.

It is preferable to reduce the contact resistance of the fitting connection terminals. In order to reduce the contact resistance, the true contact area needs to be increased. If the contact surface is smooth microscopically with surface roughness low, the true contact area increases, and the contact resistance can therefore be reduced.

The surface roughness of the metal plating layer is preferably 0.306 μm or less, more preferably 0.185 μm or less, further preferably 0.177 μm or less, and particularly preferably 0.174 μm or less.

It is preferable that the metal body according to the present invention further have a large average crystal grain size, and it is preferable that the Vickers hardness be low. If the crystal grain size of the metal plating layer increases, the metal plating layer is softened. It is inferred that the metal plating layer is easily crushed at the time of fitting therewith, so that the contact resistance is reduced due to an increase in contact area. It is considered that the contact resistance decreases due to a large average crystal grain size and low Vickers hardness in the metal plating layer formed using a PR power supply.

The method for determining the average crystal grain size in the present invention is as follows. Three photographs were taken at each of any points on the surface of the Sn plating layer layered on the barrier layer at 8000 times using an SEM. A straight line was drawn from one end of a taken photograph to the other end, and the length of the line was measured. The number of crystal grains in the Sn plating layer that intersect the straight line was next counted.

In the present invention, a value obtained by dividing the length of the line by the number of the counted crystal grains was defined as an average crystal grain size.

The average crystal grain size in the metal plating layer is preferably 2.44 μm or more, more preferably 2.87 μm or more, further preferably 2.93 μm or more, particularly preferably 4.00 μm or more, and the most preferably 5.33 μm or more. The Vickers hardness of the metal plating layer is further preferably 14.1 HV or less, particularly preferably 13.5 HV or less, and the most preferably 12.7 HV or less.

### 2. Fitting Connection Terminal

Since the metal body according to the present invention can fully suppress whisker generation, the metal body according to the present invention can be appropriately used for a fitting connection terminal as an electric contact conducting by a mechanical junction. It is specifically preferable to use the metal body according to the present invention for a connector pin (metal terminal) of a connector, a terminal connection portion (junction region) of an FFC or an FCP to be fit to a connector, or a press fit terminal.

### 3. Method for Forming Metal Body

In a method for forming the metal body according to the present invention, the barrier layer in which the main component is Ni is formed on the metal substrate containing Cu as the main component, and the metal plating layer is formed directly on the barrier layer.

### (1) Barrier Layer Formation Step

In the formation method of the metal body according to the present invention, the barrier layer in which the main component is Ni is first formed on the metal substrate. The barrier layer formation is not particularly limited, and can be performed by a well-known plating method using an electroplating device.

### (2) Metal Plating Layer Formation Step

The metal plating layer is next formed directly on the barrier layer by PR plating treatment. The PR plating treatment is treatment in which the plating layer is formed when the forward current passed to deposit the metal and the reverse current passed to dissolve the metal are passed alternately and repeatedly.

As the PR plating treatment conditions, the current density is more than 5 A/dm² and 50 A/dm² or less, and the duty ratio is more than 0.8 and less than 1. If the current density is 5 A/dm² or less, Sn is not fine deposited at the time of passing forward current, Cu diffuses easily, and the intermetallic compound grows. In order to adjust the thickness to a desired film thickness, energization time has to be increased, and the productivity is affected. If the current density exceeds 50 A/dm², the surface is burnt. The current density is preferably 8 to 30 A/dm².

If the duty ratio is 0.8 or less, the metal plating layer cannot be originally formed. If the duty ratio is 1, the current is direct-current current, and whiskers grow. The duty ratio is preferably 0.85 to 0.99.

The energization time is not particularly limited, and is suitably adjusted so that the thickness is adjusted to a required film thickness. When the metal plating layer having a film thickness of around 5 μm is formed, the time is a time of 270 seconds or less. Although the frequency is not particularly limited, either, the frequency is preferably 0.004 Hz to 3 kHz, more preferably 0.01 to 100 kHz, and particularly preferably 0.05 to 9 Hz from the viewpoint of further shortening the whisker length.

Since, in the method for forming the metal body according to the present invention, the current density is thus higher than in the conventional PR plating method, the plating layer having a desired film thickness can be formed for a short period of time as compared with the conventional PR plating method.

In the present invention, it is preferable that, in the PR plating treatment, the forward current value of the forward current passed to deposit the metal directly on the barrier layer is lower than the reverse current value of the reverse current passed to dissolve the metal directly on the barrier layer. In the present invention, the forward current passed to deposit the metal directly on the barrier layer represents current that flows in the same direction as the direction of current that flows at the time of direct-current plating treatment as shown in FIG. 4. The reverse current passed to dissolve the metal directly on a barrier layer represents current that flows in the direction opposite to the direction of current that flows at the time of the direct-current plating treatment.

When current is generally passed at the time of plating treatment, crystalline nuclei are generated on the substrate surface. When the metal plating layer grows, the metal plating layer grows around these crystal nuclei. A difference in the growth degree is therefore seen even in the same metal plating layer microscopically, and unevenness is formed on the metal plating layer.

It is inferred that current is concentrated on projections at the time of plating treatment, and the use of a PR power supply however enables the projections to be selectively dissolved at the time of the flow of reverse current and the metal plating layer to be smoothed. It is inferred that when reverse current flows, the formation of crystalline nuclei is suppressed. It is therefore believed that in the ratio (iₒₙ/iᵣₑᵥ) of the impression current value (forward current value: iₒₙ) to the reverse current value (iᵣₑᵥ), iₒₙ and iᵣₑᵥ being one of the set values of the PR power supply, by setting up the ratio so that the value of iᵣₑᵥ is larger than iₒₙ, the dissolution of the projections of the crystals is promoted, the crystalline nucleus formation can be suppressed, the metal plating layer is smoothed, and the crystal grain size is made coarse. It is believed that if the crystal grain size is large, the hardness of the metal plating layer tends to decrease, the hardness of a metal plating layer is therefore softened by the use of the PR power supply. Especially if the frequency is less than 10 kHz, the value of iᵣₑᵥ larger than iₒₙ enables whiskers to be further fully suppressed.

The iₒₙ/iᵣₑᵥ is preferably 1/10 or more and less than 1/1, more preferably ⅕ or more and ion/-rev less than 1/1, further preferably ⅓ to 1/1.2, and particularly preferably ½ to 1/1.5.

A plating solution to be used in the method for forming the metal body according to the present invention is not particularly limited, and a commercial metal plating solution may be used. For example, a metal plating solution that is an acidic bath comprising Sn-based alloy or pure Sn containing 95% by mass or more of Sn is used as the metal plating solution.

A Cu plating layer should not be layered between the Ni plating layer and the metal plating layer from the viewpoint of suppressing internal stress whiskers. Since, in the present invention, the metal plating layer is formed under the above-mentioned conditions, heat treatment is unnecessary.

### EXAMPLES

### (1) Manufacturing of Evaluation Samples

In order to prove an effect of the present invention, an Ni-plated Cu plate (size: 30 mm×30 mm×0.3 mm, nickel plating thickness: 3 μm) and an Sn plate to be used as an anode were immersed in a beaker containing a plating solution, and an Sn plating layer was formed on the Ni plating layer, and Sn plating layers having film thickness shown in Table 3 were formed by passing current at room temperature under conditions shown in Table 3.

Plating solutions adopted in plating methods are as follows.

Product produced by C. Uyemura & Co., Ltd.: model number GTC

Product produced by ISHIHARA CHEMICAL CO., LTD.: model number PF-0955

In Comparative Example 3, an Sn plating layer was formed under conditions described in Table 3. The temperature was then raised until the surface temperature of the substrate was 270° C., the temperature was subsequently maintained for 6 seconds, and the substrate was thereafter air-cooled to form a metal plating layer.

### (2) Calculation of Film Thickness of Sn Plating Layer, Cross Section of Sn Plating Layer, and Area Ratio

The evaluation samples manufactured as mentioned above were cut out by FIB using SMI3050SE (manufactured by Hitachi High-Tech Science Corporation), and sectional SEM photographs were taken.

Each of the sections was subjected to qualitative analysis by an INCAx-act (manufactured by Oxford Instruments plc), which is an EDS, and an intermetallic compound was identified. The cross section of the Sn plating layer and the area ratio were calculated as follows.

1) The total area of the intermetallic compound in the Sn plating layer (μm²) was determined from the sectional SEM photograph using image-processing software.

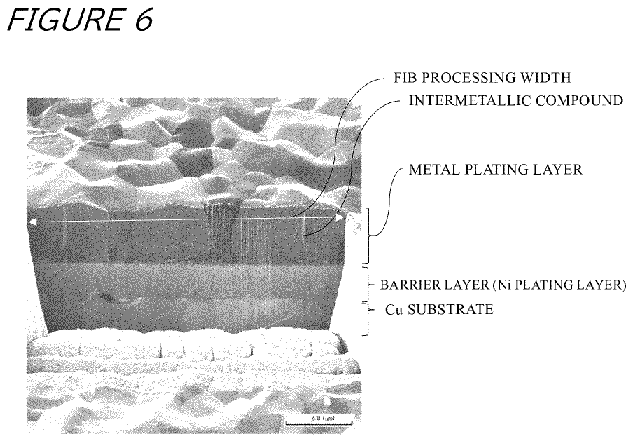

2) For example, as shown in FIG. 5 and FIG. 6, the FIB processing width and the film thickness of the metal plating layer were found from the section SEM photograph, and the total cross section of Sn plating layer was found. Film thicknesses at any ten points were measured, and the film thickness of the metal plating layer was calculated as the average value thereof.

3) The area ratio was calculated by {(area of intermetallic compound (m²))/(total cross section of Sn plating layer (m²))}×100 (%) from the thus obtained area of the intermetallic compound (μm²) and total cross section of the Sn plating layer (μm²).

### (3) Whisker Length

The Ni-plated Cu plate on which the Sn plating layer was formed was measured for the whisker length by a spherical indenter method based on “Method for testing whiskers of connectors for electronic equipment” prescribed by JEITA RC-5241. In this measurement, three samples manufactured under the same conditions were provided, the maximum whisker lengths of the samples were measured, and the average thereof was calculated as the whisker length.

A tester and conditions used for the test are as shown below.

### Tester

Load tester satisfying the specifications prescribed in “4.4 Load tester” of JEITA RC-5241 (diameter of zirconia spherical indenter: 1 mm)

### Test Conditions

Load: 300 g

Test period: 10 days (240 hours)

### Measuring Device and Condition

FE-SEM: Quanta FEG250 (manufactured by FEI Company Japan Ltd.)

Accelerating voltage: 10 kV

As a result of the measurement, a sample having a whisker length of 20 μm or less was estimated to be “good” as a sample in which whisker generation was suppressed, and a sample having a whisker length of more than 20 μm was estimated to be “poor” as a sample in which whisker generation was not able to be suppressed.

### (4) Surface Roughness

The sections of the samples used in the evaluation of the above-mentioned (2) were observed using a real color confocal microscope (manufactured by Lasertec Corporation, OPTELICS C130) with an objective lens with a magnification of 100 times to measure the surface roughnesses. The surface roughnesses Ra at any ten points were measured, and the average thereof was calculated as the surface roughness.

### (5) Average Crystal Grain Size

Three photographs at each of any points on the Sn plating layer surface of each sample manufactured in the above-mentioned (1) were taken at 8000 times with an SEM. A straight line was drawn from the left end to the right end in each of the taken photographs, and the length of the line was measured. In the Sn plating layer, the number of crystal grains that intersects the straight line was next counted. A value obtained by dividing the length of the line by the number of the counted crystal grains was defined as an average crystal grain size in the taken SEM photograph.

### (6) Vickers Hardness

Any three points on the surface of each Sn plating layer were measured using a micro Vickers hardness tester (HM-200D (manufactured by Mitutoyo Corporation)) under the conditions that the load was 1 mN, and the average value thereof was defined as the hardness.

### (7) XRD Diffraction Experiment

Samples were prepared under exactly the same conditions as the above-mentioned samples measured for the whisker lengths in Examples 1 and 4 and Comparative Example 1. The samples were measured for the X-ray diffraction spectra under the following conditions by XRD (X-ray diffraction).

Analyzer: MiniFlex600 (manufactured by Rigaku Corporation)

X-ray tube: Co (40 kV/15 mA)

Scan range: 3° to 140°

Scanning speed: 10°/min

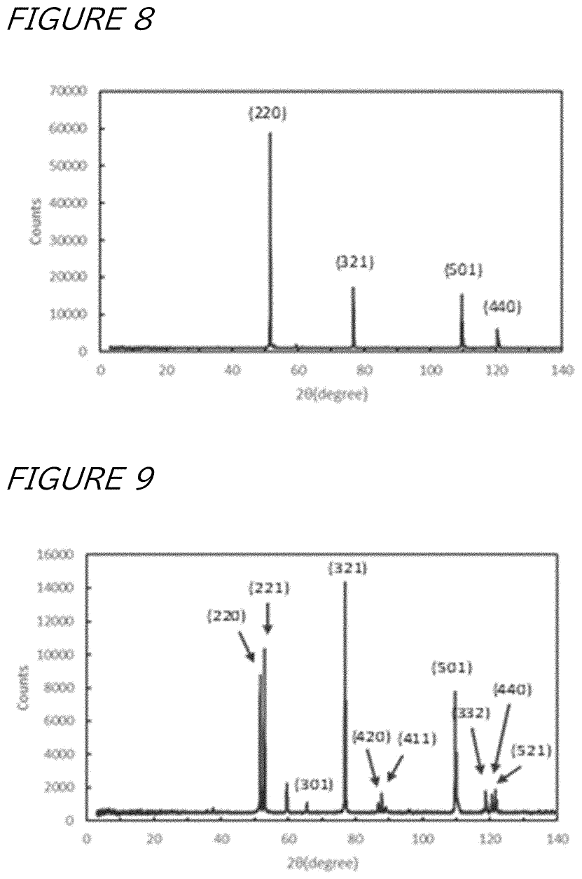

FIG. 8 is a figure showing the X diffraction spectrum of Comparative Example 1. FIG. 9 is a figure showing the X-ray diffraction spectrum of Example 1. It was found that Example 1, shown in FIG. 9, had more peaks than Comparative Example 1, shown in FIG. 8, and Example 1 was multifaceted. It was therefore found that, in PR plating, the multi-face of the crystal orientations that constitute the Sn plating layer was achieved, and even though direct-current plating was adopted, the whisker growth was suppressed. Since, in Comparative Example 1, shown in FIG. 8, the film was formed by the direct-current plating method, the multi-face was not meanwhile achieved.

The inclination angle (°) that is an angle that the c axis in the crystal orientation at each peak and the film thickness direction form was calculated from the obtained X-ray diffraction spectrum using the above-mentioned calculation method. The total value of the peak intensities was calculated. The spectral intensity ratio (%) of each peak was calculated by multiplying a value obtained by dividing each peak intensity by the calculated total value by 100.

In the present example, the crystal orientation that exhibits the maximum peak intensity ratio (%) in the X-ray diffraction spectrum was defined as (A), and the maximum peak inclination angle was defined as (a). A crystal orientation in which, the angle difference (a−b) between the inclination angle (a) of the c axis in the crystal orientation that exhibited the maximum peak intensity and an inclination angle (b) among non-maximum peak inclination angles that were inclination angles of c axes in crystal orientations that did not exhibit the maximum peak intensity ratio was in the range of ±6°, was defined as (B). The numerical values shown in the above-mentioned Tables 1 and 2 were used as the inclination angles based on the X-ray diffraction spectra. The X-ray diffraction spectral intensity ratio (%) in the dominant crystal orientation that was the sum of the peak intensity ratio (%) in the crystal orientation (A) and the peak intensity ratio (%) in the crystal orientation (B) was found.

Tables 3 and 4 show the evaluation results below.

TABLE 3

| | | | Film | | Film | | | |
|---|---|---|---|---|---|---|---|---|
| | | Materia | thickness of | Material of | thickness of | Total area of | | |
| | Metal | of barrier | barrier layer | metal plating | metal plating | metal plating | Method for forming | Plating |
| | substrate | layer | (μm) | layer | layer (μm) | layer (μm²) | metal plating layer | solution |
| Example 1 | Cu | Ni | 3 | Sn | 5.2 | 153 | PR plating method | GTC |
| Example 2 | Cu | Ni | 3 | Sn | 4.9 | 116 | PR plating method | GTC |
| Example 3 | Cu | Ni | 3 | Sn | 5.9 | 171 | PR plating method | GTC |
| Example 4 | Cu | Ni | 3 | Sn | 4.3 | 116 | PR plating method | GTC |
| Example 5 | Cu | Ni | 3 | Sn | 2.4 | 64 | PR plating method | GTC |
| Example 6 | Cu | Ni | 3 | Sn | 4.1 | 114 | PR plating method | GTC |
| Example 7 | Cu | Ni | 3 | Sn | 4.5 | 125 | PR plating method | GTC |
| Comparative | Cu | Ni | 3 | Sn | 2.8 | 83 | Direct-current | GTC |
| Example 1 | | | | | | | plating method | |
| Comparative | Cu | Ni | 3 | Sn | 4.6 | 143 | Pulse plating method | GTC |
| Example 2 | | | | | | | | |
| Comparative | Cu | Ni | 3 | Sn | 3.1 | 93 | Direct-current | GTC |
| Example 3 | | | | | | | plating method | |
| Comparative | Cu | Ni | 3 | — | — | — | PR plating method | GTC |
| Example 4 | | | | | | | | |
| Comparative | Cu | Ni | 3 | Sn | 4.0 | 107 | PR plating method | GTC |
| Example 5 | | | | | | | | |
| Comparative | Cu | Ni | 3 | Sn | 4.1 | 111 | PR plating method | GTC |
| Example 6 | | | | | | | | |
| Comparative | Cu | Ni | 3 | Sn | 4.0 | 109 | Direct-current | PF-095S |
| Example 7 | | | | | | | plating method | |
| Comparative | Cu | Ni | 3 | Sn | 3.4 | 95 | Direct-current | GTC |
| Example 8 | | | | | | | plating method | |
| Comparative | Cu | Ni | 3 | Sn | 4.3 | 116 | Direct-current | GTC |
| Example 9 | | | | | | | plating method | |
| Comparative | Cu | Ni | 3 | Sn | 4.7 | 129 | Direct-current | PF-095S |
| Example 10 | | | | | | | plating method | |

| | | | | | | | Area ratio of | | | Average | |
|---|---|---|---|---|---|---|---|---|---|---|---|
| | Current | | | | | | intermetallic | Whisker | Surface | crystal | Vickers |
| | density | Duty | Frequency | Energization | | Heat | compound | length | roughness | grain size | hardness |
| | (A/dm²) | ratio | (Hz) | time (s) | iₒₙ/iᵣₑᵥ | treatment | (%) | (μm) | (Ra) | (μm) | (HV) |
| Example 1 | 10 | 0.9 | 0.1 | 270 | 1/1.66 | Untreated | 11 | ◯ (15) | 0.174 | 5.33 | 11.0 |
| Example 2 | 10 | 0.9 | 0.1 | 180 | 1/1 | Untreated | 10 | ◯ (19) | 0.307 | 2.43 | 14.2 |
| Example 3 | 10 | 0.85 | 0.1 | 270 | 1/1.66 | Untreated | 4 | ◯ (11) | 0.185 | 5.47 | 10.6 |
| Example 4 | 20 | 0.85 | 0.1 | 240 | 1/1.66 | Untreated | 6 | ◯ (17) | 0.166 | 8.13 | 11.7 |
| Example 5 | 50 | 0.9 | 0.1 | 90 | 1/1.66 | Untreated | 2 | ◯ (11) | 0.159 | 5.87 | 11.4 |
| Example 6 | 7 | 0.9 | 0.1 | 290 | 1/1.66 | Untreated | 6 | ◯ (15) | 0.177 | 6.00 | 11.8 |
| Example 7 | 10 | 0.85 | 0.1 | 270 | 1/1.66 | Untreated | 3 | ◯ (16) | 0.147 | 7.43 | 12.7 |
| Comparative | 10 | — | — | 90 | — | Untreated | 33 | X (71) | 0.407 | 2.53 | 17.1 |
| Example 1 | | | | | | | | | | | |
| Comparative | 10 | 0.8 | — | 90 | — | Untreated | 21 | X (24) | 0.477 | 3.07 | 15.8 |
| Example 2 | | | | | | | | | | | |
| Comparative | 10 | — | — | 90 | — | Treated | 33 | X (23) | 0.021 | — | 20.8 |
| Example 3 | | | | | | | | | | | |
| Comparative | 10 | 0.8 | 0.1 | 270 | 1/1.66 | Untreated | — | — | — | — | — |
| Example 4 | | | | | | | | | | | |
| Comparative | 5 | 0.9 | 0.1 | 300 | 1/1.66 | Untreated | 22 | X (23) | 0.227 | 2.93 | 14.3 |
| Example 5 | | | | | | | | | | | |
| Comparative | 3 | 0.9 | 0.1 | 500 | 1/1.66 | Untreated | 36 | X (32) | 0.248 | 3.87 | 15.2 |
| Example 6 | | | | | | | | | | | |
| Comparative | 20 | — | — | 60 | — | Untreated | 21 | X (34) | 0.380 | 3.27 | 15.3 |
| Example 7 | | | | | | | | | | | |
| Comparative | 50 | — | — | 45 | — | Untreated | 21 | X (37) | 0.398 | 1.50 | 24.0 |
| Example 8 | | | | | | | | | | | |
| Comparative | 7 | — | — | 110 | — | Untreated | 22 | X (25) | 0.413 | 2.70 | 16.3 |
| Example 9 | | | | | | | | | | | |
| Comparative | 10 | — | — | 90 | — | Untreated | 21 | X (25) | 0.400 | 3.03 | 15.4 |
| Example 10 | | | | | | | | | | | |

Underlined items mean that the items are out of the scope of the present invention.

TABLE 4

| | | | | A: Crystal orientation in which | | |
|---|---|---|---|---|---|---|
| | | | | X-ray diffraction spectral | | |
| | | X-ray | | intensity ratio is maximal | X-ray diffraction | |
| | Crystal | diffraction | | B: Crystal orientation in which | spectral intensity | Maximum |
| | orientation | spectral | Inclination | difference between inclination | ratio in dominant | whisker |
| | (Miller | intensity | angle of c | angle of A and inclination angle | crystal orientation | length |
| | index) | ratio (%) | axis (°) | of B is in range of ±6° | A + B (%) | (μm) |
| Example 1 | (220) | 18.5 | 0 | | 56.0 | 15 |
| | (221) | 21.8 | 32.95 | B | | |
| | (301) | 1.4 | 31.43 | B | | |
| | (321) | 30.4 | 26.95 | A | | |
| | (420) | 1.4 | 0 | | | |
| | (411) | 2.4 | 23.97 | B | | |
| | (501) | 16.1 | 20.13 | | | |
| | (332) | 2.8 | 40.83 | | | |
| | (440) | 2.8 | 0 | | | |
| | (521) | 2.4 | 18.8 | | | |
| Example 4 | (220) | 53.2 | 0 | A | 59.5 | 17 |
| | (321) | 9.9 | 26.95 | | | |
| | (501) | 27.9 | 20.13 | | | |
| | (440) | 6.3 | 0 | B | | |
| | (101) | 0.9 | 61.39 | | | |
| | (411) | 1.8 | 23.97 | | | |
| Comparative | (220) | 61.3 | 0 | A | 66.7 | 71 |
| Example 1 | (321) | 17.2 | 26.95 | | | |
| | (501) | 16.1 | 20.13 | | | |
| | (440) | 5.4 | 0 | B | | |

Since Examples 1 to 7 satisfied all the requirements of the present invention, the growth of the intermetallic compound in the Sn plating layer was suppressed, and the whisker length was able to be shortened. It was also found that since the ion/irev was less than 1/1 in Examples 1 and 3 to 7 among the Examples, the surface roughness was low, the average crystal grain size was large, and the Vickers hardness was low as compared with Example 2. When Examples 1 and 3 to 7 are used especially for fitting connection terminals such as connectors, the insertability/removability is therefore improved, and contact resistance is reduced.

Meanwhile, since, in Comparative Examples 1, 3, and 7 to 10, the direct-current plating method was used, the intermetallic compound grew, and the whisker length was lengthened. Since, in Comparative Example 2, the pulse plating method was used, the growth of the intermetallic compound was suppressed to some extent as compared with the case that the direct-current plating method was used. The growth of the intermetallic compound was not however able to be suppressed to such an extent that the whisker length was shortened. Although, in Comparative Example 4, the PR plating method was used, the duty ratio was low, and an Sn plating layer was not able to be formed. Although, in Comparative Example 5 and Comparative Example 6, the PR plating method was used, the growth of the intermetallic compound was not able to be suppressed due to low current density, and the whisker length was lengthened.

In order to make the effect of the present Example understood, the present Example will be further described using figures.

FIG. 5 shows a sectional SEM photograph of Comparative Example 1. FIG. 6 shows a sectional SEM photograph of Example 1 according to the present invention. It was found that since, in FIG. 5, the Sn plating layer was formed using the direct-current plating method, a large amount of an intermetallic compound was generated in the Sn plating layer. On the other hand, it was found that since, in FIG. 6, the Sn plating layer was formed using the PR plating method, the diffusion of Cu was suppressed, and an intermetallic compound was hardly therefore generated in the Sn plating layer. It is therefore believed that, in the present Example, internal stress can be further fully reduced.

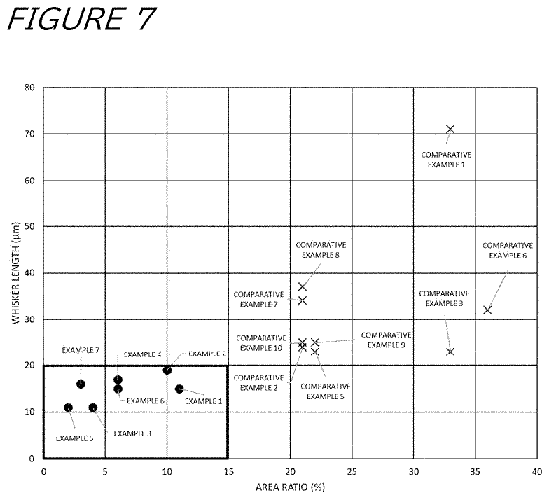

FIG. 7 is a figure showing the relationship between the area ratio of the intermetallic compound and the whisker length. As is clear from FIG. 7, it was found that since, in the Examples, the area ratio of the intermetallic compound was 20% or less, the whisker length was short, and since, in all the Comparative Examples, the area ratio of the intermetallic compound exceeded 20%, the whisker was lengthened. It was thus found that the whisker length tended to be shortened if the area ratio of the intermetallic compound in the Sn plating layer was lower.

Table 4 summarizes the relationship among the crystal orientations of βSn, the inclination angle that is an angle that the c axis therein forms with the film thickness direction, and the maximum whisker length in Example 1, Example 4, and Comparative Example 1.

As is clear from Table 4, in Example 1, the peak intensity ratio in the crystal orientation (321) in which the peak intensity ratio is the maximum in the X-ray diffraction spectrum is 30.4%. The maximum peak inclination angle (a) that was an angle that the c axis in the crystal orientation thereof and the film thickness direction formed was 26.95°, and this crystal orientation was called “A”. Crystal orientations in which the difference (a−b) between the non-maximum peak inclination angle (b) that was an angle that the c axes in crystal orientations other than (321) and the film thickness direction formed and the maximum peak inclination angle (a) as in the range of ±6° were (221), (301), and (411), and these crystal orientations were called “B”. The peak intensity ratios thereof were 21.8%, 1.4%, and 2.4% respectively. The “X-ray diffraction spectral intensity ratio in the dominant crystal orientation” that was the sum of these intensity ratios and the maximum peak intensity ratio was 56.0%. The maximum whisker length of Example 1 was 15 μm.

In Example 4, the peak intensity ratio of the crystal orientation (220) wherein the peak intensity is the maximum in the X-ray diffraction spectrum is 53.2%. The maximum peak inclination angle (a) that was an angle that the c axis in the crystal orientation thereof and the film thickness direction formed was 0°, and this crystal orientation was called “A”. A crystal orientation in which the difference (a−b) between the non-maximum peak inclination angle (b) that was an angle that the c axis in crystal orientations other than (220) and the film thickness direction formed and the maximum peak inclination angle (a) was in the range of ±6° was (440), and this crystal orientation was called “B”. The peak intensity ratio thereof was 6.3%. The “X-ray diffraction spectral intensity ratio in the dominant crystal orientation” that was the sum of this intensity ratio and the maximum peak intensity ratio was 59.5%. The maximum whisker length of Example 4 was 17 μm.

In Comparative Example 1, the peak intensity ratio of the crystal orientation (220) wherein the peak intensity is the maximum in the X-ray diffraction spectrum is 61.3%. The maximum peak inclination angle (a) that was an angle that the c axis in the crystal orientation thereof and the film thickness direction formed was 0°, and this crystal orientation was called “A”. A crystal orientation in which the difference (a−b) between the non-maximum peak inclination angle (b) that was an angle that the c axes in crystal orientations other than (220) and the film thickness direction formed and the maximum peak inclination angle (a) was in the range of ±6° was (440), and this crystal orientation was called “B”. The peak intensity ratio thereof was 5.4%. The “X-ray diffraction spectral intensity ratio in the dominant crystal orientation” that was the sum of this intensity ratio and the maximum peak intensity ratio was 66.7%. The maximum whisker length of Comparative Example 1 was 71 μm.

As mentioned above, it was confirmed that if “the X-ray diffraction spectral intensity ratio in the dominant crystal orientation” was high, the whisker growth tended to be large. FIG. 8, FIG. 9, and Table 4 also showed that the crystal orientation of the Sn plating layer was complicated by PR plating. It is therefore believed that, in the present example, external stress can be dispersed more fully, and the whisker growth is further suppressed.

1-9. (canceled)

10. A fitting connection terminal, comprising a barrier layer comprising Ni as a main component formed on a metal substrate comprising Cu as a main component, and a metal plating layer comprising Sn as a main component formed directly on the barrier layer,
wherein the metal plating layer has a Sn content of 50% by mass or more of the metal plating layer and a Sn content of 50% by mass or more of the metal plating layer, and
wherein, in a cross section of the fitting connection terminal, an area ratio that is a ratio of an area of an intermetallic compound containing Sn and Cu in the metal plating layer to a cross section of the metal plating layer is 20% or less.

11. The-fitting connection terminal according to claim 10, wherein the metal plating layer comprises an Sn-based alloy containing at least one element selected from Ag, Bi, Cu, In, Ni, Co, Ge, Ga, Sb, and P.

12. The fitting connection terminal according to claim 10, wherein, in an X-ray diffraction spectrum of the metal plating layer, a sum of a peak intensity ratio (%) in a crystal orientation exhibiting a maximum peak intensity and a peak intensity ratio (%) in a crystal orientation in which an angle difference between a maximum peak inclination angle and a non-maximum peak inclination angle is in the range of ±6° is 59.4% or less,
wherein the maximum peak inclination angle is an angle that a c axis in the crystal orientation exhibiting the maximum peak intensity and a film thickness direction of the metal plating layer form, and
wherein the non-maximum peak inclination angle is an angle that a c axis in a crystal orientation exhibiting a peak intensity other than the maximum peak intensity and the film thickness direction of the metal plating layer form.

13. The fitting connection terminal according to claim 10, wherein a surface roughness of the metal plating layer is 0.306 μm or less.

14. The fitting connection terminal according to claim 10, wherein an average crystal grain size of the metal plating layer is 2.44 8 2m or more.

15. The fitting connection terminal according to claim 10, wherein a Vickers hardness of the metal plating layer is 14.1 HV or less.

16. A method for forming the fitting connection terminal according to claim 10, comprising:
a barrier layer formation step of forming the barrier layer containing Ni as a main component on a metal substrate containing Cu as the main component; and
a metal plating layer formation step of forming a metal plating layer directly on the barrier layer by PR plating treatment in which a current density is more than 5 A/dm² and 50 A/dm² or less, and a duty ratio is more than 0.8 and less than 1.

17. The method for forming a fitting connection terminal according to claim 16, wherein, in the PR plating treatment, a forward current value of a forward current passed to deposit a metal directly on the barrier layer is lower than a reverse current value of a reverse current passed to dissolve the metal directly on the barrier layer.
